(19) United States
(12) Patent Application Publication
(10) Pub. No.: US 2007/0231616 A1
(43) Pub. Date: Oct. 4, 2007

(54) Magnetic recording medium

(75) Inventors: Toshiharu Takeda, Odawara-shi (JP); Katsuhiko Meguro, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/727,941

(22) Filed: Mar. 29, 2007

(30) Foreign Application Priority Data
Mar. 29, 2006 (JP) 2006-091896

(51) Int. Cl. G11B 5/706

(52) U.S. Cl. 428/847.3; 428/848.8

(57) ABSTRACT

A magnetic recording medium including a nonmagnetic substrate and a magnetic layer, wherein the nonmagnetic substrate is made from a polyethylene naphthalate and has a thickness of 6.5 μm or smaller, and the magnetic recording medium has a creep deformation of 0.30% or less in a longitudinal direction of the magnetic recording medium under a tensile stress of 15.7 MPa applied in the longitudinal direction at 60° C. for 50 hours.

### FIELD OF THE INVENTION

This invention relates to a magnetic recording medium having improved dimensional stability particularly in a high temperature environment. More particularly it relates to a magnetic recording medium designed to, while securing the surface properties, have improved resistance to nonuniform elongation even during storage in a high temperature environment and thereby be capable of recording and reproducing data with high reliability.

### BACKGROUND OF THE INVENTION

With increase in storage capacity of hard disks, data backup tapes with a memory capacity of 100 GB or more per pack have now been available. Further increase of capacity of backup tapes is indispensable to cope with further increase of storage capacity of hard disks.

Data recording/reproduction reliability, as well as the increased capacity, is a very important requirement. A backup tape is essentially required to record and reproduce data accurately even after storage under severe environmental conditions, for example in a high temperature environment. However, cases are observed in which a magnetic recording medium undergoes dimensional changes attributed to deformation (due to, e.g., creep) of a member constituting the medium in severe conditions, which can result in a failure to accurately record and reproduce data.

Reduction in tape thickness to increase the tape length per pack is also effective to achieve an increase in capacity per pack. A tape medium with a reduced thickness, however, tends to be stretched nonuniformly by driving tension during recording and reproduction, which can result in reduced running stability.

To solve these problems, JP-A-2000-251239 proposes a magnetic recording medium including a polyethylene terephthalate substrate having a thickness of 7 μm or smaller and at least one magnetic layer and having a creep deformation of less than 0.04% under a tensile stress of 19.1 MPa applied in the longitudinal direction at 50° C. for 25 minutes. The magnetic recording medium is described as not undergoing nonuniform elongation even when stored or used in a severe environment and therefore having improving durability, particularly cycle durability. According to the present inventors' study, it has turned out that the magnetic recording medium having been heat treated under the conditions used in Examples of JP-A-2000-251239 has deteriorated surface smoothness (i.e., an increased surface roughness Ra), resulting in a failure to meet the surface requirements for high-density recording and to obtain sufficient read output.

### SUMMARY OF THE INVENTION

An object of the invention is to provide a magnetic recording medium designed to, while securing surface properties, exhibit resistance to nonuniform elongation even during storage in a high temperature environment and thereby be capable of recording and reproducing data with high reliability.

The inventors have studied dimensional stability of a nonmagnetic substrate, one of members constituting a magnetic recording medium and found as a result that a magnetic recording medium accomplishing the above object can be obtained by using a polyethylene naphthalate (PEN) film having been subjected to a specific heat treatment.

The present invention provides a magnetic recording medium including a nonmagnetic substrate and at least one magnetic layer. The nonmagnetic substrate is a PEN film having a thickness of 6.5 μm or smaller. The magnetic recording medium has a creep deformation of not more than 0.30% in the longitudinal direction under a tensile stress of 15.7 MPa applied in the longitudinal direction at 60° C. for 50 hours.

The invention also provides preferred embodiments of the magnetic recording medium, in which:

the magnetic layer has an average surface roughness Ra (roughness average; arithmetic average deviation from mean line) of 1 to 3 nm, or the nonmagnetic substrate has not more than 0.30% of a creep deformation in the longitudinal direction under a tensile stress of 15.7 MPa applied in the longitudinal direction at 60° C. for 50 hours, or the magnetic recording medium further includes a nonmagnetic layer between the nonmagnetic substrate and the magnetic layer.

According to the present invention, nonuniform elongation of a magnetic recording medium during storage in a high temperature environment is suppressed while retaining the surface properties. The magnetic recording medium of the invention therefore exhibits highly reliable write/read performance.

### DETAILED DESCRIPTION OF THE INVENTION

The invention is described below in further detail.

The magnetic recording medium of the invention is characterized by its longitudinal creep deformation as low as 0.30% or less when a tensile stress of 15.7 MPa is applied at 60° C. for 50 hours in the longitudinal direction.

Suitable means for obtaining a magnetic recording medium satisfying the recited creep deformation condition include previously heat-treating a nonmagnetic substrate at a temperature lower than the glass transition temperature (Tg) of the substrate by 25° C. or more. The heat treatment is preferably effected at a temperature lower than the Tg of the substrate by 30° C. or more. A still preferred heat treating temperature is lower than the Tg of the substrate by 35° C. or more. The lower limit of the heat treating temperature would be, for example, 50° to 70° C. The treating time is, for example, 1 to 240 hours, preferably 5 to 168 hours, still preferably 10 to 120 hours. Temperatures lower than 50° C. could be useful but needs too long treating times. After the heat treatment, the substrate is slowly cooled to room temperature, and coating compositions are then applied and dried. The temperatures of drying following coating is desirably decided so that the web temperature may not exceed the Tg of the substrate. If the web temperature exceeds the Tg of the substrate, there is a fear that the magnetic recording medium fails to meet the creep deformation requirement.

The glass transition temperature Tg as used in the invention is a temperature at the maximum loss modulus in dynamic viscoelasticity measurement at 10 Hz. More specifically, measurement is made between 15° C. and 200° C. at 10 Hz with a known dynamic viscoelasticity measurement system, such as dynamic mechanical spectrometer DMS6100 connected to station EXSTAR 6000 (from Seiko Instruments Co., Ltd.)

The creep deformation specified in the present invention is the amount of deformation measured when a tensile stress of 15.7 MPa is applied in the longitudinal direction of a test piece of the magnetic recording medium at 60° C. for 50 hours. Measurement is carried out as follows. A known measuring system, for example, a thermomechanical analyzer TM-9300 from Ulvac-Riko Inc. is used. A specimen measuring 5 mm in width and 15 mm in length is cut out of a medium with the length parallel with the longitudinal direction of the medium and set on the analyzer. A tensile stress of 0.6 MPa is first applied in the longitudinal direction of the specimen at a measuring temperature of 60° C. for 30 minutes, followed by applying a tensile stress of 15.7 MPa for 50 hours in the same direction at the same temperature. The length of the specimen after application of 0.6 MPa×30 mins and before application of 15.7 MPa×50 hrs is taken as an initial length. A creep deformation (creep elongation) is obtained in terms of percentage of the change in length after application of 15.7 MPa×50 hrs to the initial length as calculated according to equation:

Creep deformation (%)=[(length of specimen after application of tensile stress−initial length)/initial length]×100

The creep deformation of the magnetic recording medium of the invention is 0.30% or less. As long as this requirement is satisfied, the magnetic recording medium achieves improvement in dimensional stability while securing its surface properties. The creep deformation is preferably 0.20% or less, still preferably 0.15% or less.

### 1. Nonmagnetic Substrate

The nonmagnetic substrate that can be used in the invention is a polyethylene naphthalate (PEN) film.

Nonmagnetic substrates commonly used in magnetic recording media include polyethylene terephthalate, polyamide, polyamide-imide, aromatic polyamide as well as PEN. It is only PEN that can clear the recited creep requirement to produce desired effects when subjected to the above-described heat treatment, the reason of which has not been made clear though.

A PEN film may previously be surface modified by a corona discharge treatment, a plasma treatment, an adhesion enhancing treatment, a heat treatment, etc. A biaxially stretched PEN film is also useful.

It is preferred that the PEN substrate have a creep deformation of 0.30% or less in the longitudinal direction. The creep deformation of the PEN substrate can be measured in the same manner as of the magnetic recording medium. The creep deformation of the PEN substrate is still preferably 0.20% or less, even still preferably 0.15% or less. It is desirable for the PEN substrate to retain the recited preferred creep deformation even after it is coated with a magnetic or nonmagnetic coating composition on one or both sides thereof and dried to provide a magnetic recording medium. Whether the PEN substrate in a magnetic recording medium has the preferred creep deformation can be confirmed by the measurement on the substrate left after dissolving all the coating layers (inclusive of a backcoat, described later) with methyl ethyl ketone.

A PEN film before being subjected to the above-described heat treatment preferably has a roughness average Ra of 1.0 to 4.0 nm, still preferably 2.0 to 3.5 nm.

### 2. Magnetic Layer and Nonmagnetic Layer

The binders that can be used to form the magnetic layer, the nonmagnetic layer, and a backcoat include conventionally known thermoplastic resins, thermosetting resins and reactive resins, and mixtures thereof. Examples of useful thermoplastic resins include homo- or copolymers containing a unit derived from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal, a vinyl ether, etc.; polyurethane resins, and various rubber resins.

Examples of useful thermosetting resins and reactive resins include phenolic resins, epoxy resins, thermosetting polyurethane resins, urea resins, melamine resins, alkyd resins, reactive acrylic resins, formaldehyde resins, silicone resins, epoxy-polyamide resins, polyester resin/isocyanate prepolymer mixtures, polyester polyol/polyisocyanate mixtures, and polyurethane/polyisocyanate mixtures. For the details of the thermoplastic, thermosetting, and reactive resin binders, Plastic Handbook published by Asakura Shoten can be referred to.

Known electron beam (EB)-curing resins can be used in the magnetic layer. Use of an EB curing resin in the magnetic layer brings about improvement in coating film strength, which leads to improved durability, and improvement in surface smoothness, which leads to improved electromagnetic characteristics. The details of the EB curing resins and methods of producing them are described in JP-A-62-256219.

The binder resins can be used either individually or as a combination thereof. Use of a polyurethane resin is preferred. Examples of preferred polyurethane resins include a polyurethane resin (A) which is prepared by reacting (A-1) a polyol having a cyclic structure and an alkylene oxide chain and having a molecular weight of 500 to 5000 (e.g., hydrogenated bisphenol A or hydrogenated bisphenol A polypropylene oxide adduct), (A-2) a polyol having a cyclic structure and a molecular weight of 200 to 500 that serves as a chain extender, and (A-3) an organic diisocyanate and contains a polar group; a polyurethane resin (B) which is prepared by reacting (B-1) a polyester polyol composed of an aliphatic dibasic acid component (e.g., succinic acid, adipic acid or sebacic acid) and an aliphatic diol component having a branched alkyl side chain and containing no cyclic structure (e.g., 2,2-dimethyl-1,3-propanediol, 2-ethyl-2-butyl-1,3-propanediol, or 2,2-diethyl-1,3-propanediol), (B-2) an aliphatic diol having a branched alkyl side chain containing 3 or more carbon atoms and serving as a chain extender (e.g., 2-ethyl-2-butyl-1,3-propanediol or 2,2-diethyl-1,3-propanediol), and (B-3) an organic diisocyanate and contains a polar group; and (C) a polyurethane resin which is prepared by reacting (C-1) a polyol compound having a cyclic structure and an alkyl chain containing 2 or more carbon atoms (e.g., dimer diol) and (C-2) an organic diisocyanate and contains a polar group.

The polar group-containing polyurethane resin that can be used in the invention preferably has an average molecular weight of 5,000 to 100,000, still preferably 10,000 to 50,000. With the average molecular weight of 5,000 or more, the resulting coating film has high physical strength to provide a durable magnetic recording medium. With the average molecular weight of 100,000 or less, the binder resin has sufficient solvent solubility and therefore satisfactory dispersing capabilities to provide a coating dispersion with a moderate viscosity at a predetermined concentration for good workability and easy handling.

Examples of the polar group of the polyurethane resin include —COOM, —SO₃M, —OSO₃M, —P═O(OM)₂, —O—P═O(OM)₂ (wherein M is a hydrogen atom or an alkali metal base), —OH, —NR₂, —N⁺R₃ (wherein R is a hydrocarbon group), an epoxy group, —SH, —CN, and so forth. One of more of these polar groups can be incorporated through copolymerization or addition reaction. Where the polar group-containing polyurethane resin has an OH group, the OH group is preferably a branched OH group from the viewpoint of curability and durability. It is preferred for the resin to have 2 to 40, still preferably 3 to 20, branched OH groups per molecule. The amount of the polar group in the polar group-containing polyurethane resin is 10⁻¹ to 10⁻⁸ mol/g, preferably 10⁻² to 10⁻⁶ mol/g.

Examples of commercially available binder resins useful in the invention are VAGH, VYHH, VMCH, VAGF, VAGD, VROH, VYES, VYNC, VMCC, XYHL, XYSG, PKHH, PKHJ, PKHC, and PKFE (from Dow Chemical Company) ; MPR-TA, MPR-TA5, MPR-TAL, MPR-TSN, MPR-TMF, MPR-TS, MPR-TM, and MPR-TAO (from Nisshin Chemical Industry Co., Ltd.); 1000W, DX80, DX81, DX82, DX83, and 100FD (from Denki Kagaku Kogyo K.K.); MR-104, MR-105, MR110, MR100, MR555, and 400X-10A. (from Zeon Corp.); Nipporan N2301, N2302, and N2304 (from Nippon Polyurethane Industry Co., Ltd.); Pandex T-5105, T-R3080, and T-5201, Barnock D-400 and D-210-80, and Crisvon 6109 and 7209 (from Dainippon Ink & Chemicals, Inc.); Vylon UR8200, UR8300, UR-8700, RV530, and RV280 (from Toyobo Co., Ltd.); Daiferamin 4020, 5020, 5100, 5300, 9020, 9022, and 7020 (from Dainichiseika Color & Chemicals Mfg. Co., Ltd.) ; MX5004 (from Mitsubishi Chemical Corp.); Sanprene SP-150 (from Sanyo Chemical Industries, Ltd.) ; and Saran F310 and F210 (from Asahi Chemical Industry Co., Ltd.).

The amount of the binder in the magnetic or nonmagnetic layer is 5% to 50% by mass, preferably 10% to 30% by mass, based on the magnetic or nonmagnetic powder. Where a polyurethane resin, polyisocyanate, and a vinyl chloride resin are used in combination, their amounts are preferably selected from a range of 2% to 20% by mass, a range of 2% to 20% by mass, and a range of 5% to 30% by mass, respectively. In case where head corrosion by a trace amount of released chlorine is expected to occur, polyurethane alone or a combination of only polyurethane and polyisocyanate can be used. The polyurethane resin to be used preferably has a Tg of −50° to 150° C., preferably 0° to 100° C., an elongation at break of 100% to 2000%, a stress at rupture of 0.49 to 98 Mpa (0.05 to 10 kg/mm²), and a yield point of 0.49 to 98 Mpa (0.05 to 10 kg/mm²).

### Ferromagnetic Powder

The ferromagnetic powder that can be used in the magnetic layer is preferably needle-like particles having an average length (major axis length) of 20 to 50 nm, platy particles having an average length (diameter) of 10 to 50 nm or spherical or ellipsoidal particles having an average diameter of 10 to 50 nm, the details of which will be described below in the order named above.

### (1) Needle-Like Ferromagnetic Powder

Examples of the needle-like ferromagnetic powder having an average length of 20 to 50 nm include cobalt-doped ferromagnetic iron oxide powder and ferromagnetic metal powders such as ferromagnetic alloy powder. The needle-like ferromagnetic powder preferably has an average length of 20 to 40 nm, a BET specific surface area (S_{BET}) of 40 to 80 m²/g, still preferably 50 to 70 m²/g, and a crystallite size of 12 to 25 nm, still preferably 13 to 22 nm, even still preferably 14 to 20 nm.

Examples of the ferromagnetic powder includes yttrium-containing Fe, Fe—Co, Fe—Ni, and Co—Ni—Fe. A preferred yttrium content is 0.5 to 20 atom %, still preferably 5 to 10 atom %, based on Fe. With a yttrium content less than 0.5 atom %, high saturation magnetization is not achieved, resulting in reduced magnetic characteristics, which leads to reduced electromagnetic characteristics. With a yttrium content more than 20 atom %, the Fe content decreases to reduce the magnetic characteristics, resulting in reduced electromagnetic characteristics. The ferromagnetic powder may further contain up to 20 atom %, based on Fe atom, of aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. The ferromagnetic metal powder may contain a small amount of water, a hydroxide or an oxide.

An illustrative example of the preparation of a Co— and Y-doped, needle-like ferromagnetic powder is given below.

In this example an iron oxyhydroxide obtained by bubbling oxidizing gas through an aqueous suspension containing an iron (II) salt and an alkali is used as a starting material.

The iron oxyhydroxide is preferably α-FeOOH. There are two processes of preparing α-FeOOH. In a first process an iron (II) salt is neutralized with an alkali hydroxide to obtain an aqueous suspension of Fe(OH)₂, which is oxidized by bubbling oxidizing gas to obtain needle-like α-FeOOH. In a second process an iron (II) salt is neutralized with an alkali carbonate to obtain an aqueous suspension of FeCO₃, which is oxidized by bubbling oxidizing gas to obtain spindle-shaped α-FeOOH. The iron oxyhydroxide is preferably obtained by allowing an aqueous solution of an iron (II) salt and an alkali aqueous solution to react to obtain an aqueous solution containing iron (II) hydroxide, which is then oxidized with air, etc. To the iron (II) salt aqueous solution may be added a salt properly selected from a nickel salt, an alkaline earth metal (e.g., Ca, Ba or Sr) salt, a chromium salt, a zinc salt, etc. to adjust the particle shape such as an axial ratio.

The iron (II) salt is preferably iron (II) chloride or iron (II) sulfate. The alkali is preferably selected from sodium hydroxide, aqueous ammonia, ammonium carbonate, and sodium carbonate. Examples of preferred salts that can be added to the reaction system include chlorides, such as nickel chloride, calcium chloride, barium chloride, strontium chloride, chromium chloride, and zinc chloride.

Where cobalt is introduced into iron, an aqueous solution of a cobalt compound, e.g., cobalt sulfate or cobalt chloride, is mixed into the iron oxyhydroxide suspension by stirring to prepare an iron oxyhydroxide suspension containing cobalt. A yttrium is then introduced by mixing an aqueous solution of a yttrium compound into the Co-containing suspension by stirring.

In addition to yttrium, neodymium, samarium, praseodymium, lanthanum, etc. may be introduced into the needle-like ferromagnetic powder. Examples of compounds used therefor include chlorides, such as yttrium chloride, neodymium chloride, samarium chloride, praseodymium chloride, and lanthanum chloride, and nitrates, such as neodymium nitrate and gadolinium nitrate. These dopants can be used either individually or as a combination of two or more thereof.

The needle-like ferromagnetic powder preferably has a coercive force (Hc) of 159.2 to 238.8 kA/m (2,000 to 3,000 Oe), still preferably 167.2 to 230.8 kA/m (2,100 to 2,900 Oe), a saturation magnetic flux density of 150 to 300 mT (1,500 to 3,000 G), still preferably 160 to 290 mT (1,600 to 2,900 G), and a saturation magnetization (σs) of 100 to 170 A·m²/kg (100 to 170 emu/g), still preferably 110 to 160 A·m²/kg (110 to 160 emu/g).

The switching field distribution (SFD) of the needle-like ferromagnetic powder itself is preferably as small as possible, specifically 0.8 or smaller. A magnetic medium having a small SFD exhibits satisfactory electromagnetic characteristics, high output, and sharp magnetization reversal with a small peak shift, which is advantageous for high-density digital magnetic recording. The coercivity distribution can be narrowed by, for example, using goethite with a narrow size distribution, using monodisperse α-Fe₂O₃ particles, or preventing sintering of particles.

### (2) Platy Magnetic Powder

The platy magnetic powder with an average length of 10 to 50 nm that can be used in the invention is preferably hexagonal ferrite powder. Examples of the hexagonal ferrite powder include barium ferrite, strontium ferrite, lead ferrite, and calcium ferrite, and their substituted compounds such as Co-doped compounds. Specific examples are barium ferrite and strontium ferrite of magnetoplumbite type; magnetoplumbite type ferrites coated with spinel; and barium ferrite and strontium ferrite of magnetoplumbite type containing a spinel phase in part. These ferrites may contain additional elements, such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and Zn. Usually, ferrites doped with Co—Zn, Co—Ti, Co—Ti—Zr, Co—Ti—Zn, Ni—Ti—Zn, Nb—Zn—Co, Sb—Zn—Co, Nb—Zn, etc. can be used. The ferrites may contain impurities specific to the starting material or the process of preparation.

The platy magnetic powder preferably has a length of 10 to 40 nm, still preferably 10 to 25 nm.

Where the recording medium is read with an MR head, a particle length of 40 nm or smaller is preferred due to the necessity to reduce noise. Within the above range, stable magnetization is promised without involving thermal fluctuation, and noise is low to allow for high density magnetic recording.

The platy magnetic powder preferably has an aspect ratio (length to thickness ratio) of 1 to 15, still preferably 2 to 7. Within the above range, the platy particles exhibit sufficient orientation properties, hardly stack on each other, and cause reduced noise. The platy magnetic powder having the recited particle size has an S_{BET} of 10 to 200 m²/g. The specific surface area approximately agrees with the value calculated from the length and the thickness. The crystallite size is preferably 50 to 450 Å, still preferably 100 to 350 Å. The narrower the size (length and thickness) distribution, the better. While the distribution is often not normal, calculations give a standard deviation (σ) to mean size ratio of 0.1 to 2.0. To narrow the particle size distribution, the reaction system for particle formation is made as uniform as possible, and a distribution improving treatment may be added to the resulting particles, such as selective dissolution of ultrafine particles in an acid solution.

The platy magnetic powder can be designed to have a coercive force Hc of about 39.8 to 398 kA/m (500 to 5,000 Oe) Although a higher Hc is more advantageous for high density recording, the Hc is limited by the write head ability. A generally used range is from about 63.7 to 318.4 kA/m (800 to 4,000 Oe), preferably 119.4 to 278.6 kA/m (1,500 to 3,500 Oe). When the saturation magnetization of a head exceeds 1.4 T, the Hc is preferably 159.2 kA/m (2,000 Oe) or higher.

The Hc is controllable by the particle size (length and thickness), the kinds and amounts of constituent elements, the site of substitution by the dopant element, reaction conditions of particle formation, and so on. The saturation magnetization as is 40 to 80 A·m²/kg (40 to 80 emu/g). While a higher σs is more advantageous, a saturation magnetization tends to decrease as the particle size becomes smaller. It is well known that the saturation magnetization can be improved by using a magnetoplumbite type ferrite combined with a spinel type ferrite or by properly selecting the kinds and amounts of constituent elements. It is also possible to use a wurtzite type hexagonal ferrite powder.

For the purpose of improving dispersibility, it is practiced to treat the platy magnetic powder with a substance compatible with a dispersing medium or the binder resin. Organic or inorganic compounds can be used as a surface treating substance. Typical examples are an oxide or a hydroxide of Si, Al or P, silane coupling agents, and titanium coupling agents. The surface treating substance is usually used in an amount of 0.1% to 10% by mass based on the magnetic powder. The pH of the powder is of importance for dispersibility. The pH usually ranges from about 4 to 12. From the standpoint of chemical stability and storage stability of the magnetic recording medium, a pH of about 6 to 10 is recommended while the optimal p value depends on the dispersing medium or the binder resin to be used. The water content of the powder is also influential on dispersibility. While varying according to the kinds of the dispersing medium or the binder resin, the optimal water content usually ranges from 0.01% to 2.0% by mass.

Methods of preparing hexagonal ferrite powder to be used in the invention include, but are not limited to, (i) a glass crystallization method including the steps of blending barium oxide, iron oxide, an oxide of a metal that is to substitute iron, and a glass forming oxide (e.g., boron oxide) in a ratio providing a desired ferrite composition, melting the blend, rapidly cooling the melt into an amorphous solid, re-heating the solid, washing and grinding the solid to obtain a barium ferrite crystal powder, (ii) a hydrothermal method including the steps of neutralizing a solution of barium ferrite-forming metal salts with an alkali, removing by-products, heating in a liquid phase at 100° C. or higher, washing, drying, and grinding to obtain a barium ferrite crystal powder, and (iii) a coprecipitation method including the steps of neutralizing a solution of barium ferrite-forming metal salts with an alkali, removing by-products, drying, treating at 1100° C. or lower, and grinding to obtain a barium ferrite crystal powder.

### (3) Spherical or Ellipsoidal Ferromagnetic Powder

The spherical or ellipsoidal ferromagnetic powder having an average diameter of 10 to 50 nm that can be used in the invention is typically exemplified by iron nitride based ferromagnetic powder containing Fe₁₆N₂ as a main phase. The iron nitride based powder may contain, in addition to Fe and N, Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, and Nb. A preferred N content is 1.0 to 20.0 atom % based on Fe.

The spherical or ellipsoidal iron nitride based magnetic powder preferably has an average diameter of 10 to 40 nm, still preferably 10 to 25 nm, an average aspect ratio of 1 to 2, an S_{BET} of 30 to 100 m²/g, still preferably 50 to 70 m²/g, and a crystallite size of 12 to 25 nm, still preferably 13 to 22 nm. The iron nitride based magnetic powder preferably has a saturation magnetization σs of 50 to 200 A·m²/kg (emu/g), still preferably 70 to 150 A·m²/kg (emu/g).

The particle size of magnetic powders used in the invention is measured from high-resolution transmission electron micrographs. The particle size is represented by (1) the length of a major axis where a particle is needle-shaped, spindle-shaped or columnar (with the height greater than the maximum diameter of the base), (2) a maximum diameter (length) of a main plane or a base where a particle is platy or columnar (with the thickness or height smaller than the maximum diameter of the base), or (3) a circle equivalent diameter where a particle is spherical, polyhedral or amorphous and has no specific major axis. The “circle equivalent diameter” is calculated from a projected area.

The average particle size of powder is an arithmetic average calculated from the particle sizes of about 350 primary particles measured as described above. The term “primary particles” denotes particles dependent of each other without agglomeration.

The term “average aspect ratio” of powder particle is an arithmetic average of length/breadth (major axis length/minor axis length) ratios of particles defined in (1) above or an arithmetic average of length/thickness (diameter/thickness) ratios of particles defined in (2) above. The term “breadth” or “minor axis length” as used herein means the maximum length of axes perpendicular to the length or major axis of a particle defined in (1) above. Particles defined in (3) above, having no distinction between major and minor axes, are regarded to have an aspect ratio of 1 for the sake of convenience.

The average particle size of particles defined in (1) and (2) above can also be referred to as an average length, and that of particles defined in (3) can also be referred to as an average diameter. The term “variation coefficient” with reference to particle sizes is defined to be a percentage of standard deviation to average.

When in using the magnetic powder having the recited average particle size (i.e., 20 to 50 nm as for needle-like particles or 10 to 50 nm as for platy, spherical or ellipsoidal particles), the magnetic recording medium has improved surface properties, increased read output, and reduced particle noise in reading, thereby exhibits excellent electromagnetic characteristics.

Further, the magnetic powder with the recited average particle size has improved dispersibility and reduced demagnetization due to thermal fluctuations, thereby exhibiting excellent electromagnetic characteristics. When in using magnetic powder whose average particle size exceeds the recited upper limit, there is a tendency that the medium surface becomes rough, resulting in reduction of output and that particle noise increases, which can result in deterioration of electromagnetic characteristics.

The magnetic layer can contain additives including abrasives, lubricants, dispersing agents or aids, antifungals, antistatics, antioxidants, solvents, and carbon black.

Examples of useful additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polyolefins, polyglycols, polyphenyl ethers; aromatic ring-containing organic phosphonic acids, such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids, such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphoric acid esters, such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, a-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates, such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; alkylsulfonic esters and alkali metal salts thereof; fluorine-containing alkylsulfuric esters and alkali metal salts thereof; monobasic fatty acids having 10 to 24 carbon atoms, either saturated or unsaturated and straight chain or branched, such as lauric acid, myristic acid, palmitic acid, stearic acid, behenic acid, oleic acid, linoleic acid, linolenic acid, elaidic acid, and erucic acid, and metal salts thereof; mono-, di- or higher esters of fatty acids prepared between monobasic fatty acids having 10 to 24 carbon atoms, either saturated or unsaturated and straight-chain or branched, and any one of mono- to hexahydric alcohols having 2 to 22 carbon atoms (either saturated or unsaturated and straight-chain or branched), alkoxyalcohols having 12 to 22 carbon atoms (either saturated or unsaturated and straight-chain or branched) or monoalkyl ethers of alkylene oxide polymers, such as butyl stearate, octyl stearate, amyl stearate, isooctyl stearate, octyl myristate, butyl laurate, butoxyethyl stearate, anhydrosorbitol monostearate, anhydrosorbitol distearate, and anhydrosorbitol tristearate; aliphatic acid amides having 2 to 22 carbon atoms; and aliphatic amines having 8 to 22 carbon atoms. The alkyl, aryl or aralkyl moiety of the above-recited additive compounds may be substituted with a nitro group, a halogen atom (e.g., F, Cl or Br), a halogenated hydrocarbon group (e.g., CF₃, CCl₃ or CBr₃) or a like substituent.

The magnetic layer can also contain surface active agents. Suitable surface active agents include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group or a sulfuric ester group; and amphoteric ones, such as amino acids, aminosulfonic acids, amino alcohol sulfuric or phosphoric esters, and alkyl betaines. For the details of the surface active agents, refer to Kaimen Kasseizai Binran published by Sangyo Tosho K.K.

The above-recited dispersing agents, lubricants, and like additives do not always need to be 100% pure and may contain impurities, such as isomers, unreacted materials, by-products, decomposition products, and oxides. The proportion of the impurities is preferably 30% by mass at the most, still preferably 10% by mass or less.

Specific examples of the additives are NAA-102, hardened castor oil fatty acids, NAA-42, Cation SA, Nymeen L-201, Nonion E-208, Anon BF, and Anon LG from NOF Corp.; FAL-205 and FAL-123 from Takemoto Yushi K.K.; Enujelv OL from New Japan Chemical Co., Ltd.; TA-3 from Shin-Etsu Chemical Industry Co., Ltd.; Armid P from Lion Armour Co., Ltd.; Duomeen TDO from Lion Corp.; BA-41G from Nisshin Oil Mills, Ltd.; Profan 2012E, Newpol PE 61, and Ionet MS-400 from Sanyo Chemical Industries, Ltd.

Organic solvents known in the art can be used in the preparation of the magnetic coating composition for the formation of the magnetic layer, including ketones, such as methyl ethyl ketone, methyl isobutyl ketone, diisobutyl ketone, cyclohexanone, isophorone, and tetrahydrofuran; alcohols, such as methanol, ethanol, propanol, butanol, isobutyl alcohol, isopropyl alcohol, and methylcyclohexanol; esters, such as methyl acetate, butyl acetate, isobutyl acetate, isopropyl acetate, ethyl lactate, and glycol acetate; glycol ethers, such as glycol dimethyl ether, glycol monoethyl ether, and dioxane; aromatic hydrocarbons, such as benzene, toluene, xylene, cresol, and chlorobenzene; chlorinated hydrocarbons, such as methylene chloride, ethylene chloride, carbon tetrachloride, chloroform, ethylenechlorohydrin, and dichlorobenzene; N,N-dimethylformamide; and hexane. They can be used as a mixture thereof at any mixing ratio.

These organic solvents do not always need to be 100% pure and may contain impurities, such as isomers, unreacted matter, by-products, decomposition products, oxidation products, and water. The impurity content is preferably 30% or less, still preferably 10% or less. The organic solvent used in the formation of the magnetic layer and that used in the formation of the nonmagnetic layer are preferably the same in kind but may be different in amount. It is advisable to use a solvent with high surface tension (e.g., cyclohexanone or dioxane) in the nonmagnetic layer to improve coating stability. Specifically, it is important that the arithmetic mean of the surface tensions of the solvents of the upper magnetic layer not exceed that of the lower nonmagnetic layer. A solvent with somewhat high polarity is preferred for improving dispersing capabilities for powders. In this connection, the solvent system preferably contains at least 50% of a solvent having a dielectric constant of 15 or higher. The solubility parameter of the solvent or the solvent system is preferably 8 to 11.

The kinds and amounts of the above-described dispersing agents, lubricants or surface active agents to be used can be decided as appropriate to the type of the layer to which they are added. The following is a few illustrative examples of manipulations using these additives. (i) A dispersing agent has a property of being adsorbed or bonded to fine solid particles via its polar groups. It is adsorbed or bonded via the polar groups mostly to the surface of ferromagnetic powder when used in a magnetic layer or the surface of nonmagnetic powder in a nonmagnetic layer (described later). It is assumed that, after once being absorbed to metal or metal compound particles, an organophosphorus compound, for instance, is hardly desorbed therefrom. As a result, the ferromagnetic powder or nonmagnetic powder treated with a dispersing agent appears to be covered with an alkyl group, an aromatic group or the like, which makes the particles more compatible with a binder resin component and more stable in their dispersed state. (ii) Since lubricants exist in a free state, bleeding of lubricants is controlled by using fatty acids having different melting points between the magnetic layer and the nonmagnetic layer or by using esters different in boiling point or polarity between the magnetic layer and the nonmagnetic layer. (iii) Coating stability is improved by adjusting the amount of a surface active agent. (iv) The amount of the lubricant in the nonmagnetic layer is increased to improve the lubricating effect. All or part of the additives can be added at any stage of preparing the magnetic or nonmagnetic coating composition. For example, the additives can be blended with the magnetic powder before kneading, or be mixed with the magnetic powder, the binder, and a solvent in the step of kneading, or be added during or after the step of dispersing or immediately before coating.

Carbon blacks that can be used in the magnetic layer include furnace black for rubber, thermal black for rubber, carbon black for color, and acetylene black. The physical properties (hereinafter described) of the carbon black to be used in the magnetic layer should be optimized as appropriate for the effect desired. In some cases, a combined use of carbon black of different species produce better results.

The carbon black has a specific surface area of 100 to 500 m²/g, preferably 150 to 400 m²/g, an oil (DBT) absorption of 20 to 400 ml/100 g, preferably 30 to 200 ml/100 g, and an average particle size of 5 to 80 nm, preferably 10 to 50 nm, still preferably 10 to 40 nm. The carbon black preferably has a pH of 2 to 10, a water content of 0.1% to 10%, and a tap density of 0.1 to 1 g/ml.

Examples of commercially available carbon black products that can be used in the invention include Black Pearls 2000, 1300, 1000, 900, 800, 880, and 700 and Vulcan XC-72 from Cabot Corp.; #3050B, #3150B, #3250B, #3750B, #3950B, #950, #650B, #970B, #850B, MA-600, MA-230, #4000, and #4010 from Mitsubishi Chemical Corp.; Conductex SC, RAVEN 8800, 8000, 7000, 5750, 5250, 3500, 2100, 2000, 1800, 1500, 1255, and 1250 from Columbian Carbon; and Ketjen Black EC from Akzo Nobel Chemicals.

Carbon black having been surface treated with a dispersing agent, etc., resin-grafted carbon black, or carbon black with its surface partially graphitized may be used. Carbon black may previously been dispersed in a binder before being added to a coating composition. In selecting carbon black species for use, reference can be made, e.g., to Carbon Black Kyokai (ed.), Carbon Black Binran.

The carbon black species can be used either individually or as a combination thereof. The carbon black can be used in an amount of 0.1% to 30% by mass based on the magnetic powder. Carbon black serves for antistatic control, reduction of frictional coefficient, reduction of light transmission, film strength enhancement, and the like. These functions depend on the species. Accordingly, it is understandably possible, or rather desirable, to optimize the kinds, amounts, and combinations of the carbon black species for each layer according to the intended purpose with reference to the above-mentioned characteristics, such as particle size, oil absorption, conductivity, pH, and so forth.

The magnetic layer can contain one or more of known inorganic powders mostly having a Mohs hardness of 6 or higher as an abrasive. Examples of such abrasives include α-alumina, β-alumina, silicon carbide, chromium oxide, cerium oxide, α-iron oxide, corundum, artificial diamond, silicon nitride, titanium carbide, titanium oxide, silicon dioxide, and boron nitride. A composite of these abrasives (an abrasive surface treated with another) may be used.

The abrasive preferably has a tap density of 0.3 to 2 g/ml, a water content of 0.1% to 5%, a pH of 2 to 11, and a specific surface area (SBET) of 1 to 30 m²/g. The abrasive grains may be needle-like, spherical or cubic. Angular grains are preferred for high abrasive performance.

Specific examples of commercially available abrasives that can be used in the invention are AKP-12, AKP-15, AKP-20, AKP-30, AKP-50, HIT 20, HIT-30, HIT-55, HIT 60, HIT 70, HIT 80, HIT 100 from Sumitomo Chemical Co., Ltd.; ERC-DBM, HP-DBM, and HPS-DBM from Reynolds Metals Co.; WA10000 from Fujimi Kenmazai K.K.; UB 20 from Uyemura & CO., LTD; G-5, Chromex U2, and Chromex U1 from Nippon Chemical Industrial Co., Ltd.; TF100 and TF140 from Toda Kogyo Corp.; Beta-Random Ultrafine from Ibiden Co., Ltd.; and B-3 from Showa Mining Co., Ltd.

The roughness average Ra (arithmetic average deviation from mean line) of the magnetic layer is preferably 1 to 3 nm, still preferably 1.2 to 2.8 nm, even still preferably 1.5 to 2.8 nm. The average surface roughness Ra as referred to in the present invention denotes the one measured with a three-dimensional imaging surface structure analyzer, New View 5022 from ZyGo Corp. that operates using scanning white light interferometry. The measuring conditions are: scan length, 5 μm; objective lens, 20X; intermediate lens, 1.0X; and assessment area, 260 μm×350 μm. The image data are processed by HPF (high pass filtering) at a wavelength of 1.65 μm and LPF (low pass filtering) at a wavelength of 50 μm.

### Nonmagnetic Layer

The magnetic recording medium of the invention preferably includes at least one nonmagnetic layer containing nonmagnetic powder and a binder between the nonmagnetic substrate and the magnetic layer. The same binder as used in the magnetic layer can be used in the nonmagnetic layer.

### (Nonmagnetic Powder)

As long as the nonmagnetic layer is substantially nonmagnetic, it may contain magnetic powder.

The nonmagnetic powder that can be used in the nonmagnetic layer may be either organic or inorganic. The nonmagnetic layer may contain carbon black according to necessity. Inorganic substances useful as the nonmagnetic powder include metals, metal oxides, metal carbonates, metal sulfates, metal nitrides, metal carbides, and metal sulfides.

Examples of the inorganic substances include titanium oxides (e.g., titanium dioxide), cerium oxide, tin oxide, tungsten oxide, ZnO, ZrO₂, SiO₂, Cr₂O₃, α-alumina having an α-phase content of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, and silicon carbide. They can be used either individually or in combination. Preferred among them are α-iron oxide and titanium oxides.

The shape of the nonmagnetic powder particles may be any of needle-like, spherical, polygonal and platy shapes.

The crystallite size of the nonmagnetic powder is preferably 4 nm to 1 μm, still preferably 40 to 100 nm. Particles with the crystallite size ranging from 4 nm to 1 μm provide appropriate surface roughness while securing dispersibility.

The nonmagnetic powder preferably has an average particle size of 5 nm to 2 μm. Particles with the recited size provide appropriate surface roughness while securing dispersibility. If desired, nonmagnetic powders different in average particle size may be used in combination, or a single kind of a nonmagnetic powder having a broadened size distribution may be used to produce the same effect. A still preferred particle size of the nonmagnetic powder is 10 to 200 nm.

The specific surface area of the nonmagnetic powder preferably ranges 1 to 100 m²/g, still preferably 5 to 70 m²/g, even still preferably 10 to 65 m²/g. When the specific surface area ranges 1 to 100 m²/g, the nonmagnetic powder provides appropriate surface roughness and is dispersible in a desired amount of a binder.

The oil (DBP) absorption of the powder is preferably 5 to 100 ml/100 g, still preferably 10 to 80 ml/100 g, even still preferably 20 to 60 ml/100 g.

The specific gravity of the powder is preferably 1 to 12, still preferably 3 to 6. The tap density of the powder is preferably 0.05 to 2 g/ml, still preferably 0.2 to 1.5 g/ml. When the tap density falls within the range of 0.05 to 2 g/ml, the powder is easy to handle with little dusting and tends to be less liable to stick to equipment.

The nonmagnetic powder preferably has a pH of 2 to 11, still preferably between 6 and 9. With the pH ranging between 2 and 11, an increase in frictional coefficient of the magnetic recording medium experienced in a high temperature and high humidity condition or due to migration of a fatty acid can be averted.

The water content of the nonmagnetic powder is preferably 0.1% to 5% by mass, still preferably 0.2% to 3% by mass, even still preferably 0.3% to 1.5% by mass. When the water content ranges 0.1 to 5% mass, the powder is easy to disperse, and the resulting coating composition has a stable viscosity.

The ignition loss of the powder is preferably not more than 20% by mass. The smaller the ignition loss, the better.

The inorganic nonmagnetic powder preferably has a Mohs hardness of 4 to 10 to secure durability. The nonmagnetic powder preferably has a stearic acid adsorption of 1 to 20 μmol/m², still preferably 2 to 15 μmol/m².

The heat of wetting of the nonmagnetic powder with water at 25° C. is preferably 20 to 60 μJ/cm² (200 to 600 erg/cm²). Solvents in which the nonmagnetic powder releases the recited heat of wetting can be used.

The number of water molecules on the nonmagnetic powder at 100° to 400° C. is suitably 1 to 10 per 100 Å. The isoelectric point of the nonmagnetic powder in water is preferably pH 3 to 9.

It is preferred that the nonmagnetic powder be surface treated to have a surface layer of Al₂O₃, SiO₂, TiO₂, ZrO₂, SnO₂, Sb₂O₃, or ZnO. Among them, preferred for dispersibility are Al₂O₃, SiO₂, TiO₂, and ZrO₂, with Al₂O₃, SiO₂, and ZrO₂ being still preferred. These surface treating substances may be used either individually or in combination. According to the purpose, a composite surface layer can be formed by co-precipitation or a method comprising first applying alumina to the nonmagnetic particles and then treating with silica or vise versa. The surface layer may be porous for some purposes, but a homogeneous and dense surface layer is usually preferred.

Specific examples of commercially available nonmagnetic powders that can be used in the nonmagnetic layer include Nanotite from Showa Denko K.K.; HIT-100 and ZA-G1from Sumitomo Chemical Co., Ltd.; DPN-250, DPN-250BX, DPN-245, DPN-270BX, DPB-550BX, and DPN-550RX from Toda Kogyo Corp.; titanium oxide series TTO-51B, TTO-55A, TTO-55B, TTO-55C, TTO-55S, and TTO-55D, SN-100, MJ-7, and α-iron oxide series E270, E271, and E300 from Ishihara Sangyo Kaisha, Ltd.; STT-4D, STT-30D, STT-30, and STT-65C from Titan Kogyo K.K.; MT-100S, MT-100T, MT-150W, MT-500B, MT-600B, T-100F, and T-500HD from Tayca Corp.; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO2P25 from Nippon Aerosil Co., Ltd.; 100A and 500A from Ube Industries, Ltd.; and Y-LOP from Titan Kogyo K.K. and calcined products thereof. Preferred of them are titanium dioxide and α-iron oxide.

Carbon black can be incorporated into the nonmagnetic layer to reduce the surface resistivity, to decrease light transmission, and to obtain a desired micro Vickers hardness. The nonmagnetic layer generally has a micro Vickers hardness of 25 to 60 kg/mm² (0.245 to 0.588 GPa). A preferred micro Vickers hardness for good head contact is 30 to 50 kg/mm² (0.294 to 0.490 GPa). A micro Vickers hardness can be measured with a thin film hardness tester (HMA-400 supplied by NEC Corp.) having an indenter equipped with a three-sided pyramid diamond tip, 80 angle and 0.1 μm end radius. Magnetic recording tapes are generally standardized to have an absorption of not more than 3% for infrared rays of around 900 nm. For example, the absorption of VHS tapes is standardized to be not more than 0.8%. Useful carbon black species for these purposes include furnace black for rubber, thermal black for rubber, carbon black for colors, and acetylene black.

The carbon black in the nonmagnetic layer has a specific surface area of 100 to 500 m²/g, preferably 150 to 400 m²/g, an oil (DBP) absorption of 20 to 400 ml/100 g, preferably 30 to 200 ml/100 g, and an average particle size of 5 to 80 nm, preferably 10 to 50 nm, still preferably 10 to 40 nm. The carbon black preferably has a pH of 2 to 10, a water content of 0.1 to 10%, and a tap density of 0.1 to 1 g/ml.

Specific examples of commercially available carbon black products for use in the nonmagnetic layer include Black Pearls 2000, 1300, 1000, 900, 800, 880, and 700, and Vulcan XC-72 from Cabot Corp.; #3050B, #3150B, #3250B, #3750B, #3950B, #950, #650B, #970B, #850B, and MA-600 from Mitsubishi Chemical Corp.; Conductex SC and RAVEN 8800, 8000, 7000, 5750, 5250, 3500, 2100, 2000, 1800, 1500, 1255, and 1250 from Columbian Carbon; and Ketjen Black EC from Akzo Nobel Chemicals.

Carbon black having been surface treated with a dispersing agent, etc., resin-grafted carbon black, or carbon black with its surface partially graphitized may be used. Carbon black may previously been dispersed in a binder before being added to a coating composition. Carbon black is used in an amount of 50% by mass or less based on the above-described inorganic powder and 40% by mass or less based on the total mass of the nonmagnetic layer. The above-recited carbon black species can be used either individually or as a combination thereof. In selecting carbon black species for use in the nonmagnetic layer, reference can be made, e.g., to Carbon Black Kyokai (ed.), Carbon Black Binran.

The nonmagnetic layer can contain organic powder according to the purpose. Useful organic powders include acrylic-styrene resin powders, benzoguanamine resin powders, melamine resin powders, and phthalocyanine pigments. Polyolefin resin powders, polyester resin powders, polyamide resin powders, polyimide resin powders, and polyethylene fluoride resin powders are also usable. Methods of preparing these resin powders are disclosed, e.g., in JP-A-62-18564 and JP-A-60-255827.

With respect to the other details of the nonmagnetic layer, that is, selection of the kinds and amounts of binder resins, lubricants, dispersing agents, additives, and solvents and methods of dispersing, the techniques as for the magnetic layer apply. In particular, known techniques with regard to the amounts and kinds of binder resins, additives, and dispersing agents to be used in a magnetic layer are useful.

### 3. Backcoat

Magnetic tapes for computer data recording are generally required to have higher stability and durability in repeated running than video tapes or audio tapes. A backcoat can be provided on the opposite side of the nonmagnetic substrate to the magnetic layer to maintain such running properties. A coating composition for the formation of a backcoat is a dispersion of particulate components (e.g., an abrasive and an antistatic) and a binder in an organic solvent. Various inorganic pigments and carbon black can be used as the particulate component. Examples of the binder include nitrocellulose, phenoxy resins, vinyl chloride resins, and polyurethane resins, and mixtures thereof.

### 4. Smoothing Layer

The magnetic recording medium of the invention may have a smoothing layer between the nonmagnetic substrate and the nonmagnetic or magnetic layer. The smoothing layer is formed by applying a coating composition containing a radiation-curing compound (a compound having a radiation-curing functional group in its molecule) on the nonmagnetic substrate and curing the coating layer by irradiation.

The radiation-curing compound preferably has a molecular weight of 200 to 2000. With such a relatively low molecular weight, the compound becomes flowable in calendering to provide a smooth surface.

The radiation-curing compound is exemplified by bifunctional acrylate compounds having a molecular weight of 200 to 2000, preferably including (meth)acrylic acid adducts of bisphenol A, bisphenol F, hydrogenated bisphenol A, hydrogenated bisphenol F or an alkylene oxide adducts thereof.

The radiation-curing compound may be used in combination with a polymeric binder. Usable polymeric binders include known thermoplastic resins, thermosetting resins, reactive resins, and mixtures thereof. When ultraviolet light is used as a radiation, a polymerization initiator is preferably used in combination. Useful polymerization initiators include known radical polymerization initiators, photo cationic polymerization initiators, and photo amine generators.

### 5. Layer Structure

The thickness of the PEN substrate used in the invention is not more than 6.5 μm, preferably 3.0 to 6.0 μm, still preferably 3.0 to 5.5 μm. A substrate thickness exceeding 6.5 μm fails to provide a thin magnetic recording medium capable of achieving high capacity. The thickness of the backcoat provided on the opposite side of the substrate to the magnetic layer side is preferably 0.1 to 1.0 μm, still preferably 0.2 to 0.8 μm.

The thickness of the magnetic layer is usually 0.15 μm or smaller, e.g., 0.01 to 0.10 μm, preferably 0.02 to 0.08 μm, still preferably 0.03 to 0.08 μm, while it is to be optimized according to the saturation magnetization and the gap length of a head used and the wavelength range of recording signals. The variations in magnetic layer thickness is preferably within +50%, still preferably within ±40%. It is only necessary that the magnetic recording medium has one magnetic layer. The magnetic layer may be divided into two or more sublayers different in magnetic characteristics. Known techniques relating to a multilayered magnetic layer apply to that structure.

The thickness of the nonmagnetic layer usually ranges 0.2 to 3.0 μm, preferably 0.3 to 2.5 μm, still preferably 0.4 to 2.0 μm. The lower nonmagnetic layer manifests the essentially expected effects as long as it is substantially nonmagnetic. In other words, the effects of the lower layer are produced even when it contains a small amount of a magnetic substance, either intentionally or unintentionally. Such a layer formulation is construed as being included under the scope of the present invention. The term “substantially nonmagnetic” as referred to above means that the lower nonmagnetic layer has a residual magnetic flux density of 10 mT (100 G) or less or a coercive force of 7.96 kA/m (100 Oe) or less. Preferably, both the residual magnetic flux density and coercive force of the nonmagnetic layer are zero.

### 6. Preparation Method

Methods of preparing the magnetic or nonmagnetic coating compositions include at least the steps of kneading and dispersing and, if desired, the step of mixing which is provided before or after the step of kneading and/or the step of dispersing. Each step may be carried out in two or more divided stages. Any of the materials, including the magnetic powder, nonmagnetic powder, binder, carbon black, abrasive, antistatic, lubricant, and solvent, can be added at the beginning of or during any step. Individual materials may be added in divided portions in two or more steps. For example, polyurethane may be added dividedly in the kneading step, the dispersing step, and a mixing step provided for adjusting the viscosity of the dispersion. To accomplish the object of the invention, known techniques for coating composition preparation can be applied as part of the method. The kneading step is preferably performed using a kneading machine with high kneading power, such as an open kneader, a continuous kneader, a pressure kneader, and an extruder. For the details of the kneading operation, reference can be made in JP-A-1-106338 and JP-A-1-79274. In the step of dispersing, glass beads can be used to disperse the magnetic or nonmagnetic mixture. High-specific-gravity dispersing beads, such as zirconia beads, titania beads, and steel beads are suitable. The size and mixing ratio of the dispersing beads should be optimized. Known dispersing machines can be used.

The magnetic recording medium of the invention is typically produced by coating a moving web of a PEN film substrate with a magnetic or nonmagnetic coating composition by a wet coating technique to give a dry thickness as designed. A plurality of coating compositions, whether magnetic or nonmagnetic, may be applied successively or simultaneously. Examples of suitable coating equipment include an air doctor (air knife) coater, a blade coater, a rod coater, an extrusion coater, a squeegee coater, an impregnation coater, a reverse roll coater, a transfer roll coater, a gravure coater, a kiss roll coater, a cast coater, a spray coater, and a spin coater. For the details of coating techniques, reference can be made to Saishin Coating Gijjyutsu, published by Sogo Gijyutsu Center, May 31, 1983.

In the production of tape media, the ferromagnetic powder is oriented in the machine direction using a cobalt magnet or a solenoid. In the case of disk media, although sufficiently isotropic orientation could sometimes be obtained without orientation using an orientation apparatus, it is preferred to use a known random orientation apparatus in which cobalt magnets are obliquely arranged in an alternate manner or an alternating magnetic field is applied with a solenoid. In using ferromagnetic metal powder, the “isotropic orientation” is preferably in-plane, two-dimensional random orientation but may be in-plane and perpendicular, three-dimensional random orientation. While hexagonal ferrite powder is liable to have in-plane and perpendicular, three-dimensional random orientation but could have in-plane two-dimensional random orientation. It is also possible to provide a disk with circumferentially isotropic magnetic characteristics by perpendicular orientation in a known manner, for example, by using facing magnets with their polarities opposite. Perpendicular orientation is particularly preferred for high density recording. Circumferential orientation may be achieved by spin coating.

It is preferred that the drying position of the coating film can be controlled by controlling the temperature and the amount of drying air and the coating speed, and the coating speed preferably ranges 20 to 1,000 m/min and the temperature of the drying air is preferably 60° C. or more. Preliminary drying may be carried out at an appropriate degree before the magnet zone.

After drying, the coating layer is usually subjected to a smoothing treatment using, for example, supercalender rolls, and a heat treatment. By the smoothing treatment, the voids generated by the solvent being released on drying disappear to increase the packing density of the ferromagnetic powder in the magnetic layer thereby providing a magnetic recording medium with improved electromagnetic characteristics.

Calendering is carried out with rolls of heat-resistant plastics, such as epoxy resins, polyimide, polyamide and polyimide-amide. Metallic rolls are also usable. Calendering is preferably carried out at a roll temperature of 60° to 100° C., still preferably 70° to 100° C., even still preferably 80° to 100° C., under a pressure of 100 to 500 kg/cm (98 to 490 kN/m), still preferably 200 to 450 kg/cm (196 to 441 kN/m), even still preferably 300 to 400 kg/cm (294 to 392 kN/m). The calendering temperature is preferably not higher than the Tg of the substrate. It is still preferred that the calendering temperature be controlled so that the web temperature may not exceed the Tg.

A calendered film is usually subjected to heat treatment for the purpose of reducing thermal shrinkage. The heat treatment as a means for reducing thermal shrinkage can be performed by a method in which the film in web form is heated while handling under low tension or a method in which a tape wound on a hub (e.g., a pancake or a tape pack in a cassette) is bulk-heated. The former treatment involves less possibility of the backcoat surface roughness imprinting itself on the magnetic layer but is less effective in largely reducing thermal shrinkage. On the other hand, the latter bulk heat treatment achieves marked reduction in thermal shrinkage but causes the backcoat to imprint its surface roughness in the magnetic layer, which can result in output reduction and noise increase. A high output, low noise magnetic recording medium can be supplied by production methods including the heat treatment. The resulting magnetic recording medium is then cut to widths or sizes by means of a slitter, a punching machine, etc.

### 7. Physical Properties

The magnetic layer of the magnetic recording medium according to the invention preferably has a saturation flux density of 100 to 300 mT (1,000 to 3,000 G) and a coercive force Hc of 143.3 to 318.4 kA/m (1800 to 4000 Oe), still preferably 159.2 to 278.6 kA/m (2000 to 3500 Oe). The narrower the coercive force distribution, the more preferred. Accordingly, SFD and SFDr are preferably 0.6 or smaller, still preferably 0.2 or smaller.

The magnetic recording medium of the invention has a frictional coefficient of 0.5 or less, preferably 0.3 or less, on a head at temperatures of −10° to 40° C. and humidities of 0% to 95%. The static potential is preferably −500 to +500 V. The magnetic layer preferably has an elastic modulus at 0.5% elongation of 0.98 to 19.6 GPa (100 to 2000 kg/mm²) in every in-plane direction and a breaking strength of 98 to 686 Mpa (10 to 70 kg/mm²). The magnetic recording medium preferably has an elastic modulus of 0.98 to 14.7 GPa (100 to 1500 kg/mm²) in every in-plane direction, a residual elongation of 0.5% or less, and a thermal shrinkage of 1% or less, still preferably 0.5% or less, even still preferably 0.1% or less, at temperatures of 100° C. or lower.

The glass transition temperature (at maximum loss modulus in dynamic viscoelasticity measurement at 110 Hz) of the magnetic layer is preferably 50° to 180° C., and that of the nonmagnetic layer is preferably 0° to 180° C. The loss modulus preferably ranges from 1×10⁷ to 8×10⁸ Pa (1×10⁸ to 8×10⁹ dyne/cm²). The loss tangent is preferably 0.2 or lower. Too high a loss tangent easily leads to a tack problem. It is desirable that these thermal and mechanical characteristics be substantially equal in all in-plane directions with differences falling within 10%.

The residual solvent content in the magnetic layer is preferably 100 mg/m² or less, still preferably 10 mg/m² or less. The magnetic layer and the nonmagnetic layer each preferably have a void of 30% by volume or less, still preferably 20% by volume or less. While a lower void is better for high output, there are cases in which a certain level of void is recommended. For instance, a relatively high void is often preferred for disk media, which put weight on durability against repeated use.

The magnetic layer preferably has a maximum peak-to-valley height Rₘₐₓ of 0.5 μm or smaller, a ten point mean roughness R_{z} of 0.3 μm or smaller, a maximum mean plane-to-peak height Rₚ of 0.3 μm or smaller, a maximum mean plane-to-valley depth Rᵥ of 0.3 μm or smaller, a mean plane area ratio Sr of 20% to 80%, and an average wavelength λₐ of 5 to 300 μm. The projection distribution on the substrate surface can be controlled freely by the filler to obtain optimum electromagnetic characteristics and durability. The number of projections of 0.01 to 1 μm per 0.1 mm² of the magnetic layer is freely controllable between 0 and 2000, whereby the electromagnetic characteristics and coefficient of friction can be optimized. A desired magnetic layer's surface profile is easily obtained by, for example, controlling the surface profile of the PEN substrate (which can be done by means of a filler), selecting the size and amount of the powder used in the magnetic layer, or selecting the surface profile of calender rolls. Curling of the magnetic recording medium is preferably within ±3 mm.

In the case where the magnetic recording medium has a nonmagnetic layer between the substrate and the magnetic layer, it is easily anticipated that the physical properties are varied between the lower nonmagnetic layer and the upper magnetic layers according to the purpose. For example, the elastic modulus of the magnetic layer can be set relatively high to improve running durability, while that of the nonmagnetic layer can be set relatively low to improve head contact.

The magnetic recording medium of the invention is effective in increasing recording density particularly in a linear recording system. Where the magnetic recording medium of the invention is used in a fixed head system, the track width may be 25 μm or smaller, preferably 0.1 to 10 μm, still preferably 0.1 to 6 μm, and the linear recording density may be 100 kfci or higher, preferably 100 to 500 kfci, still preferably 200 to 400 kfci. A recording apparatus for a fixed head system may be equipped with a plurality of write/read heads and may be arranged at a predetermined angle with respect to the longitudinal direction of the medium.

While any type of read heads is useful to reproduce the signals recorded on the magnetic recording medium of the invention, the magnetic recording medium is suitably used in a system using an MR head. The MR head to be used is not particularly limited and may be a GMR head or a TMR head. While any type of write heads is useful, a write head having a saturation magnetization of 1.0 T or more, preferably 1.5 T or more is preferably used.

### EXAMPLES

The present invention will now be illustrated in greater detail with reference to Examples, but it should be understood that the invention is not construed as being limited thereto. Unless otherwise noted, all the parts and percents are by mass.

### Example 1

### (1) Preparation of Magnetic Coating Composition for Formation of Upper Magnetic Layer and Nonmagnetic Coating Composition for Formation of Lower Nonmagnetic Layer

Formulation of magnetic coating composition:

| | |
|---|---|
| Ferromagnetic metal powder (Fe/Co = 100/30 | 100 parts |
| (atomic ratio); Hc: 189.6 kA/m (2400 Oe); | |
| S_{BET}: 70 m²/g; average length: 60 nm; | |
| crystallite size: 13 nm (130 A); σs: 115 A·m²/kg | |
| (125 emu/g); surface treating | |
| compound: Al₂O₃, Y₂O₃) | |
| Vinyl chloride copolymer (MR-110, from Zeon | 12 parts |
| Corp.; - SO₃Na content: 5 × 10⁻⁶ eq/g; degree | |
| of polymerization: 350; epoxy group | |
| content: 3.5 wt % in terms of monomer unit) | |
| Polyester polyurethane resin (UR-8200 from | 3 parts |
| Toyobo) | |
| Alpha-alumina (average particle size: 0.1 μm) | 3 parts |
| Carbon black (average particle size; 0.08 μm) | 0.5 parts |
| Stearic acid | 2 parts |
| Methyl ethyl ketone | 90 parts |
| Cyclohexane | 30 parts |
| Toluene | 60 parts |

Formulation of nonmagnetic coating composition:

| | |
|---|---|
| Nonmagnetic powder α-Fe₂O₃ hematite (average | 80 parts |
| length: 0.15 μm; S_{BET}: 110 m²/g; pH: 9.3; tap | |
| density: 0.98 g/ml; surface treating | |
| compound: Al₂O₃, SiO₂) | |
| Carbon black (from Mitsubishi Chemical | 20 parts |
| Corp.; average primary particle size: 16 nm; | |
| DBP absorption: 80 ml/100 g; pH: 8.0; S_{BET}: | |
| 250 m²/g; volatile content: 1.5%) | |
| Vinyl chloride copolymer (MR-110, from Zeon | 12 parts |
| Corp. | |
| Polyester polyurethane resin (UR-8200 from | 12 parts |
| Toyobo) | |
| Stearic acid | 2 parts |
| Methyl ethyl ketone | 150 parts |
| Cyclohexane | 50 parts |
| Toluene | 50 parts |

The above components of each of the magnetic coating composition and the nonmagnetic coating composition were kneaded in a kneader and then dispersed in a sand mill. To the dispersion for upper magnetic layer was added 1.6 parts of sec-butyl stearate (sec-BS). To the dispersion for lower nonmagnetic layer was added 3 parts of a polyisocyanate compound (Coronate L, from Nippon Polyurethane Industry Co., Ltd.). To each of the dispersions was further added 40 parts of a methyl ethyl ketone/cyclohexanone mixed solvent, followed by stirring and filtration through a filter having an average opening size of 1 μm to prepare a magnetic coating composition and a nonmagnetic coating composition.

### (2) Preparation of Backcoating Composition

| | |
|---|---|
| Fine carbon black (average particle size: | 100 parts |
| 20 nm) | |
| Coarse carbon black (average particle | 10 parts |
| size: 270 nm) | |
| Nitrocellulose resin | 100 parts |
| Polyester polyurethane resin | 30 parts |
| Dispersing agent | |
| Copper oleate | 10 parts |
| Copper phthalocyanine | 10 parts |
| Barium sulfate (precipitated) | 5 parts |
| Methyl ethyl ketone | 500 parts |
| Toluene | 500 parts |
| Alpha-alumina (average particle size: 0.13 μm) | 0.5 parts |

The above components were kneaded in a continuous kneader and then dispersed in a sand mill for 2 hours. To the resulting dispersion were added 40 parts of polyisocyanate (Coronate L, from Nippon Polyurethane Industry Co., Ltd.) and 1000 parts of methyl ethyl ketone, followed by agitation and filtration through a filter having an average pore size of 1 μm to prepare a coating composition for backcoat.

### (3) Preparation of Magnetic Tape

A web of 6 μm thick PEN base film (Tg: 120° C.) was heat treated in a heat treating chamber set at 90° C. for one day. After cooling the base film to room temperature, the nonmagnetic coating composition and the magnetic coating composition prepared above were applied simultaneously to the base film to dry thicknesses of 1.3 μm and 0.2 μm, respectively. While the coating layers were wet, the coated web was subjected to a magnetic orientation treatment using cobalt magnets having a magnetic flux density of 3000 Gauss (300 mT) and a solenoid having a magnetic flux density of 1500 Gauss (150 mT) and then dried by blowing 80° C. air.

The backcoating composition was applied to the opposite side of the base film to a dry thickness of 0.5 μm and dried by blowing 90° C. air to obtain a pancake of a film having a lower nonmagnetic layer and an upper magnetic layer on one side and a backcoat on the other side.

The coated film was unrolled and passed through a 7-roll calender composed of heated metal rolls and thermosetting resin-covered elastic rolls at a roll temperature of 90° and a running speed of 300 m/min, slit to 0.5 inch in width, and wound onto an LTO (linear tape-open) reel to a length of 650 m. The resulting tape pack was put into an LTO-G3 cartridge case to obtain a magnetic tape cartridge.

### Example 2

A magnetic tape cartridge was produced in the same manner as in Example 1, except that the base film was heat treated at 80° C. for 2 days.

### Example 3

A magnetic tape cartridge was produced in the same manner as in Example 1, except for changing the base film thickness to 4.5 μm.

### Example 4

A magnetic tape cartridge was produced in the same manner as in Example 2, except for changing the base film thickness to 4.5 μm.

### Example 5

A magnetic tape cartridge was produced in the same manner as in Example 1, except for changing the base film thickness to 3 μm.

### Comparative Example 1

A magnetic tape cartridge was produced in the same manner as in Example 1, except that the base film was not heat treated.

### Comparative Example 2

A magnetic tape cartridge was produced in the same manner as in Example 3, except that the base film was not heat treated.

### Comparative Example 3

A magnetic tape cartridge was produced in the same manner as in Example 1, except for replacing the PEN base film with a polyethylene terephthalate (PET; Tg: 90° C.) base film.

### Comparative Example 4

A magnetic tape cartridge was produced in the same manner as in Example 3, except for replacing the PEN base film with a polyethylene terephthalate (PET; Tg: 90° C.) base film.

### Evaluation

(a) Ra (Arithmetic Average Deviation from Mean Line)

Ra was measured by scanning white light interferometry using a 3D imaging surface structure analyzer, New View 5022 from ZyGo Corp. The measuring conditions were: scan length, 5 μm; objective lens, 20X; intermediate lens, 1.0X; and assessment area, 260 μm×350 μm. The image data were processed by HPF at a wavelength of 1.65 μm and LPF at a wavelength of 50 μm.

(b) Creep Deformation

A 5 mm by 15 mm piece cut out of the magnetic recording tape with the length parallel with the longitudinal direction of the tape medium was used as a specimen of the medium. Separately, the magnetic recording tape was treated with methyl ethyl ketone to remove the upper magnetic and lower nonmagnetic layers and the backcoat, and a 5 mm by 15 mm piece was cut out of the remaining base film with the length parallel with the longitudinal direction of the film to prepare a specimen of the base film. Measurement was performed with a thermomechanical analyzer TM-9300 from Ulvac-Riko Inc. A tensile stress of 0.6 MPa was first applied in the longitudinal direction of the specimen at a measuring temperature of 60° C. for 30 minutes, followed by applying a tensile stress of 15.7 MPa for 50 hours in the same direction at the same temperature. The length of the specimen after application of 0.6 MPa×30 mins and before application of 15.7 MPa×50 hrs was taken as an initial length. A creep deformation (creep elongation) was obtained in terms of percentage of the change in length to the initial length. Samples the creep deformation of which was 0.30% or less were judged good.

(c) Reproduction Characteristics

Data was recorded on each of the cartridge tapes obtained in Examples 1 to 4 and Comparative Example 1 to 4 and reproduced on an LTO-G3 drive. The outer part and the inner part (near the core) of the tape pack were used. The smaller one of the output values of outer part and the inner part of the tape pack was taken as initial output and expressed relative to the read output of the outer part of the tape pack of Comparative Example 1 taken as 0 dB. The tape cartridge was stored at 60° C. and 90% RH for 336 hours and then tested in the same manner as above (the same positions of the tape pack were evaluated). The smaller one of the output values of outer part and the inner part of the tape pack was taken as an output after storage of the tape and expressed relative to the read output of the outer part of the tape pack of Comparative Example 1 taken as 0 dB. The initial output values smaller than −1 dB were regarded no good (NG). The output after storage values smaller than −3 dB were regarded no good (NG).

The results of measurements and evaluations are shown in Table 1 below.

TABLE 1

| | | | | | Tape | | | |
|---|---|---|---|---|---|---|---|---|
| | | | | | Medium, | Substrate, | Read Characteristics | |
| | Substrate | | | | Creep | Creep | | After Storage |
| | | Thickness | Heat | | Deformation | Deformation | | (60° C., 90% RH × 336 hrs) |
| | Kind | (μm) | Treatment | Ra (nm) | (%) | (%) | Initial (dB) | (dB) |
| Ex 1 | PEN | 6 | 90° C./1 dy | 2.6 | 0.10 | 0.08 | −0.5 G | −1.5 G |
| Ex 2 | PEN | 6 | 80° C./2 dys | 2.5 | 0.13 | 0.10 | −0.3 G | −2.0 G |
| Ex 3 | PEN | 4.5 | 90° C./1 dy | 2.7 | 0.16 | 0.15 | −0.6 G | −2.1 G |
| Ex 4 | PEN | 45 | 80° C./2 dys | 2.6 | 0.17 | 0.16 | −0.5 G | −2.4 G |
| Ex 5 | PEN | 3 | 90° C./1 dy | 2.6 | 0.25 | 0.25 | −0.7 G | −2.8 G |
| Comp Ex 1 | PEN | 6 | no | 2.3 | 0.37 | 0.35 | 0 G | −3.3 NG |
| Comp Ex 2 | PEN | 4.5 | no | 2.5 | 0.42 | 0.39 | −0.4 G | −4.3 NG |
| Comp Ex 3 | PET | 6 | 90° C./1 dy | 3.2 | 0.18 | 0.20 | −1.2 NG | −2.8 G |
| Comp Ex 4 | PET | 4.5 | 90° C./1 dy | 3.3 | 0.20 | 0.25 | −1.4 NG | −4.0 NG |

It is seen from Table 1 that excellent reproduction characteristics both in the initial stage and after storage can be secured as long as the magnetic recording medium uses a polyethylene naphthalate substrate and has a creep deformation of 0.30% or less.

This application is based on Japanese Patent application JP 2006-91896, filed Mar. 29, 2006, the entire content of which is hereby incorporated by reference, the same as if set forth at length.

What is claimed is:

1. A magnetic recording medium comprising a nonmagnetic substrate and a magnetic layer, wherein the nonmagnetic substrate is made from a polyethylene naphthalate and has a thickness of 6.5 μm or smaller, and the magnetic recording medium has a creep deformation of 0.30% or less in a longitudinal direction of the magnetic recording medium under a tensile stress of 15.7 MPa applied in the longitudinal direction at 60° C. for 50 hours.

2. The magnetic recording medium according to claim 1, wherein the magnetic layer has a roughness average Ra of from 1 to 3 nm.

3. The magnetic recording medium according to claim 1, wherein the magnetic layer has a roughness average Ra of from 1.2 to 2.8 nm.

4. The magnetic recording medium according to claim 1, wherein the magnetic layer has a roughness average Ra of from 1.5 to 2.8 nm.

5. The magnetic recording medium according to claim 1, wherein the nonmagnetic substrate has a creep deformation of 0.30% or less in a longitudinal direction of the nonmagnetic substrate under a tensile stress of 15.7 MPa applied in the longitudinal direction at 60° C. for 50 hours.

6. The magnetic recording medium according to claim 5, wherein the creep deformation of the nonmagnetic substrate is 0.20% or less.

7. The magnetic recording medium according to claim 5, wherein the creep deformation of the nonmagnetic substrate is 0.15% or less.

8. The magnetic recording medium according to claim 1, further comprising a nonmagnetic layer between the nonmagnetic substrate and the magnetic layer.

9. The magnetic recording medium according to claim 8, wherein the nonmagnetic layer contains nonmagnetic powder and a binder.

10. The magnetic recording medium according to claim 1, wherein the creep deformation is 0.20% or less.

11. The magnetic recording medium according to claim 1, wherein the creep deformation is 0.15% orless.

12. The magnetic recording medium according to claim 1, wherein the nonmagnetic substrate has a thickness of from 3.0 to 6.0 μm.

13. The magnetic recording medium according to claim 1, wherein the nonmagnetic substrate has a thickness of from 3.0 to 5.5 μm.

14. The magnetic recording medium according to claim 1, wherein the nonmagnetic substrate is heat-treated at a temperature lower than a glass transition temperature of the substrate by 25° C. or more, before the magnetic layer is provided above the nonmagnetic substrate.

15. The magnetic recording medium according to claim 1, wherein the nonmagnetic substrate is heat-treated at a temperature lower than a glass transition temperature of the substrate by 30° C. or more, before the magnetic layer is provided above the nonmagnetic substrate.
